(19) United States
(12) Patent Application Publication
(10) Pub. No.: US 2025/0078300 A1
(43) Pub. Date: Mar. 6, 2025

(54) Apparatus and Method for Generating Depth Map

(71) Applicants: Hyundai Motor Company, Seoul (KR); Kia Corporation, Seoul (KR)

(72) Inventors: Jun Young Lim, Hwaseong-si (KR); Hyun Jee Ryu, Hwaseong-si (KR); Gun Hee Moon, Hwaseong-si (KR); Hong Ju Lee, Hwaseong-si (KR)

(21) Appl. No.: 18/816,196

(22) Filed: Aug. 27, 2024

(30) Foreign Application Priority Data
Aug. 31, 2023 (KR) 10-2023-0115835

(51) Int. Cl. G06T 7/593; G06T 5/80; G06T 7/536; G06T 17/05; G06V 20/17

(52) U.S. Cl. CPC G06T 7/593; G06T 5/80; G06T 7/536; G06T 17/05; G06V 20/17; G06T 2207/10032

(57) ABSTRACT

An apparatus for an aerial vehicle is introduced. The apparatus may comprise a camera and a processor coupled to the camera. During flight, the processor may obtain an image from the camera, transform it into a bird-eye view image, and match it with digital surface model (DSM) data. Based on this matched image, the processor may generate a depth map image. Further, the processor may utilize the depth map image to produce a signal for controlling the operation of the aerial vehicle.

### CROSS-REFERENCE TO RELATED APPLICATION

This application claims the benefit of priority to Korean Patent Application No. 10-2023-0115835, filed in the Korean Intellectual Property Office on Aug. 31, 2023, the entire contents of which are incorporated herein by reference.

### TECHNICAL FIELD

The present disclosure relates to an apparatus and a method for generating a depth map to generate the depth map using an image sensor.

### BACKGROUND

Various sensors, such as a global positioning system/inertial navigation system (GPS/INS), a radar altimeter, and a barometer, may be loaded into an aerial vehicle to obtain height information during flight. Because such an aerial vehicle requires the integrity of the sensor for airframe operation, it should be prepared for malfunctions of the various sensors while the airframe of the aerial vehicle is in flight.

A method for learning a depth map image obtained by projecting depth information onto an image obtained using a mono camera may be used to estimate the depth information using only the mono camera. To obtain a depth map image used as training data, a method for fusing a two-dimensional (2D) image obtained using the mono camera and data obtained in the same time by means of a distance sensor (e.g., a depth camera, light detection and ranging (LiDAR), or the like) and projecting distance data onto the 2D image may be used.

However, the distance sensor, such as the depth camera, is relatively very short in measurement distance. It may be difficult for a distance sensor such as LiDAR to obtain depth information of all image pixels, which is for being projected onto the 2D image, due to the number of channels of the LiDAR and a limit in the interval of the LiDAR. Due to this, it may be difficult to form a depth map image in the field of aviation. It may be difficult to obtain depth information for covering all image areas although radio detecting and ranging (RADAR) with a relatively long measurement distance is used. Furthermore, if depth data is obtained using the RADAR, it may take higher cost and data throughput.

### SUMMARY

According to the present disclosure, an apparatus may comprise a camera mounted on an aerial vehicle, and a processor coupled to the camera, wherein the processor is configured to obtain, based on information from the camera during flight of the aerial vehicle, an image, transform the obtained image into a bird-eye view image, match the bird-eye view image with digital surface model (DSM) data, generate, based on the matched bird-eye view image, a depth map image, and output, based on the depth map image, a signal for an operation control of the aerial vehicle or output, based on the depth map image, a control signal for controlling autonomous flight of the aerial vehicle.

The apparatus, wherein the processor is configured to recognize a landmark from the obtained image and obtains coordinates of a center point of the landmark.

The apparatus, wherein the processor is configured to obtain, based on the coordinates of the center point of the landmark, the DSM data.

The apparatus, wherein the processor is configured to obtain posture information of the aerial vehicle from a navigation device, correct, based on the posture information of the aerial vehicle, the obtained image, and transform, based on perspective transform, the corrected image into the bird-eye view image.

The apparatus, wherein the posture information of the aerial vehicle comprises at least one of pitch information of the aerial vehicle or roll information of the aerial vehicle.

The apparatus, wherein the processor is configured to transform data in pixels in the bird-eye view image into data in meters, and match the transformed data in meters with the DSM data to generate three-dimensional (3D) image data.

The apparatus, wherein the processor is configured to inversely transform, based on inverse perspective transform, the matched bird-eye view image into data in pixels, determine depth information based on the inversely transformed data, height information of the aerial vehicle, and posture information of the aerial vehicle, and generate the depth map image based on the determined depth information.

The apparatus, wherein the processor is configured to replace height information of the matched bird-eye view image with the determined depth information to generate the depth map image.

The apparatus, wherein the processor is configured to store the depth map image in a database server.

The apparatus, wherein the camera comprises at least one of an electro-optics sensor or infrared sensor.

According to the present disclosure, a method may comprise obtaining, based on information from a camera mounted on a flying aerial vehicle, an image, transforming, by a processor, the obtained image into a bird-eye view image, matching the bird-eye view image with digital surface model (DSM) data, generating, based on the matched bird-eye view image, a depth map image, and outputting, based on the depth map image, a signal for an operation control of the flying aerial vehicle or outputting, based on the depth map image, a control signal for controlling autonomous flight of the flying aerial vehicle.

The obtaining of the image may comprise recognizing a landmark from the obtained image and obtaining coordinates of a center point of the landmark.

The obtaining of the image may further comprise obtaining, based on the coordinates of the center point of the landmark, the DSM data.

The transforming of the obtained image into the bird-eye view image may comprise obtaining posture information of the flying aerial vehicle from a navigation device, correcting, based on the posture information of the flying aerial vehicle, the obtained image, and transforming, based on perspective transform, the corrected image into the bird-eye view image.

The posture information of the flying aerial vehicle may comprise at least one of pitch information of the flying aerial vehicle or roll information of the flying aerial vehicle.

The matching the bird-eye view image with the DSM data may comprise transforming data in pixels in the bird-eye view image into data in meters and matching the transformed data in meters with the DSM data to generate 3D image data.

The generating of the depth map image may comprise inversely transforming, based on inverse perspective transform, the matched bird-eye view image into data in pixels, determining depth information based on the inversely transformed data, height information of the flying aerial vehicle, and posture information of the flying aerial vehicle, and generating the depth map image based on the determined depth information,

The generating of the depth map image based on the determined depth information may comprise replacing height information of the matched bird-eye view image with the determined depth information to generate the depth map image.

The method may further comprise storing the depth map image in a database server.

The camera may comprise at least one of an electro-optics sensor or infrared sensor.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a configuration of an apparatus for generating a depth map according to an example of the present disclosure;

FIGS. 2 and 3 show an example of an image transformation method according to an example of the present disclosure;

FIG. 4 shows an example of a method for generating a depth map by means of map matching according to an example of the present disclosure; and

FIG. 5 shows an example of a method for generating a depth map according to an example of the present disclosure.

### DETAILED DESCRIPTION

Hereinafter, some examples of the present disclosure will be described in detail with reference to example drawings. In the drawings, the same reference numerals will be used throughout to designate the same or equivalent components. In addition, a detailed description of well-known features or functions will be ruled out in order not to unnecessarily obscure the gist of the present disclosure.

In describing components of examples of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein are to be interpreted as is customary in the art to which this present disclosure belongs. It will be understood that terms used herein should be interpreted as having a meaning that is consistent with their meaning in the context of this present disclosure and the relevant art and will not be interpreted in an idealized or overly formal sense unless expressly so defined herein.

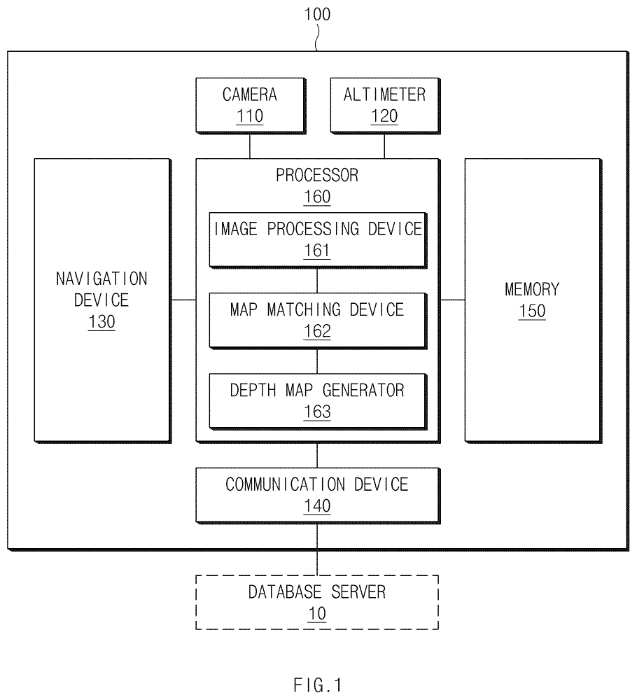

FIG. 1 shows an example of a configuration of an apparatus for generating a depth map according to an example of the present disclosure.

An apparatus 100 for generating a depth map may be mounted on an aerial vehicle. The aerial vehicle may be an aerial vehicle capable of performing autonomous flight. Referring to FIG. 1, the apparatus 100 for generating the depth map may include a camera 110, an altimeter 120, a navigation device 130, a communication device 140, a memory 150, and a processor 160. A depth map may be an image (or image channel) that includes information relating to the distance of surfaces of one or more objects from a viewpoint. A depth map may be rendered by obtaining a plurality of images from one or more viewpoints and determining a distance from one or more pixel to one or more image sensors (e.g., cameras).

The camera 110 may be mounted on the aerial vehicle to face the ground during flight. The camera 110 may capture the ground during flight and may output the captured image (or a ground image). The camera 110 may include an image sensor such as an electro-optics sensor or an infrared (EO/IR) sensor.

The altimeter 120 may be mounted on the aerial vehicle to measure an altitude (or current height information) of the aerial vehicle. The altimeter 120 may include at least one of a radar altimeter or a barometer, or any combination thereof. The altimeter 120 may include a global positioning system (GPS).

The navigation device 130 may obtain information about a location, an altitude, a speed, and/or the like of the aerial vehicle using a GPS satellite. The navigation device 130 may perform flight route guidance starting point to a destination. Although not shown in the drawing, the navigation device 130 may include a memory, a GPS receiver, a communication circuit, a processor, and/or the like.

The communication device 140 may support to perform wired and/or wireless communication between the apparatus 100 for generating the depth map and an external electronic device (e.g., a database server 10, a gateway and/or the like). The communication device 140 may include a communication processor, a communication circuit, an antenna, a transceiver, and/or the like.

The memory 150 may be a non-transitory storage medium which stores instructions executed by the processor 160. The memory 150 may be implemented at least one of storage media such as a flash memory, a hard disk, a solid state disk (SSD), a secure digital (SD) card, a random access memory (RAM), a static RAM (SRAM), a read only memory (ROM), a programmable ROM (PROM), an electrically erasable and programmable ROM (EEPROM), or an erasable and programmable ROM (EPROM).

The memory 150 may store a learning algorithm, a camera position, a camera installation angle, and/or the like. The memory 150 may store the image captured by the camera 110. The memory 150 may store a previously constructed digital surface model (DSM). The DSM may be defined as data including height information, such as all objects (e.g., a terrain, a tree, a building, an artificial structure, and the like) on the ground, as well as the ground. The memory 150 may store input data, output data, and/or the like according to an operation of the processor 160.

The processor 160 may be connected with the camera 110, the altimeter 120, the navigation device 130, the communication device 140, and the memory 150 and may control the overall operation of the apparatus 100 for generating the depth map. The processor 160 may be implemented as at least one of processing devices such as an application specific integrated circuit (ASIC), a digital signal processor (DSP), a programmable logic device (PLD), a field programmable gate array (FPGA), a central processing unit (CPU), a microcontroller, or a microprocessor. The processor 160 may include an image processing device 161, a map matching device 162, and a depth map generator 163. The image processing device 161, the map matching device 162, and the depth map generator 163 may be implemented as at least one of a hardware module executed by the processor 160 or a software module executed by the processor 160, or any combination thereof. The software module may reside on the storage medium.

The image processing device 161 may obtain an image (or a ground image) in the direction of the ground (or a lower direction) using the camera 110, while the aerial vehicle is in flight. The image processing device 161 may recognize a landmark from the image obtained by the camera 110 (e.g., using the learning algorithm). The landmark may be a geographic feature with symbolic meaning, which is located on a flight route of the aerial vehicle. The learning algorithm may learn the landmark in advance. The image processing device 161 may obtain GPS reference coordinates registered with the landmark (or coordinates of a center point of the landmark or coordinates of a central point of the landmark).

The map matching device 162 may perform coordinate system matching for map matching. The map matching device 162 may obtain posture information of the aerial vehicle from the navigation device 130 to perform the coordinate system matching. The posture information of the aerial vehicle may include roll, pitch, yaw, and the like of the aerial vehicle. The map matching device 162 may process (or transform) a two-dimensional (2D) (or a planar) ground image into a bird-eye view image using current posture information of the aerial vehicle and an angle at which the camera 110 is installed in the aerial vehicle (i.e., a camera installation angle). The bird-eye view image may be defined as an image in a state in which roll, pitch, and yaw are “0”. A bird-eye view may be taken a view above a certain distance from a ground and/or an object and may capture an area larger than a threshold (e.g., a threshold area configured in memory of the aerial vehicle). A bird-eye view image may indicate (and/or may be associated with) a perspective angle from the aerial vehicle (e.g., row, yaw, pitch information of the aerial vehicle and/or one or more cameras of the aerial vehicle). A bird-eye view image may indicate (and/or may be associated with) time information and/or other indicators of a frame of the bird-eye view image. A bird-eye view image may indicate (and/or may be associated with) one or more landmark images included in the bird-eye view image. A landmark may include one or more objects having a size greater than a threshold size.

The map matching device 162 may match the landmark (e.g., towers, bridges, stadium, national park, rivers, monuments, mountains, buildings, etc.) with a GPS/inertial navigation system (INS)-based image using the DSM. The map matching device 162 may map-match the DSM with the bird-eye view image on the basis of the coordinates of the center point of the landmark. The map matching device 162 may convert horizontal and vertical positions per image pixel (or position coordinates (x, y) on a pixel coordinate system) into meter units for map matching. The map matching device 162 may convert a data unit of the DSM into a meter unit and may match respective data around the coordinates of the center point of the landmark to add height data in meters.

The depth map generator 163 may generate a depth map image (or a depth map) of the image using a height of each of image pixel coordinates obtained by means of map matching and height information of the aerial vehicle, which is obtained by the altimeter 120. The depth map generator 163 may change data (X, Y, h) in meters, which is obtained by means of map matching, to data (x, y, h) in pixels, to generate a depth map image.

The depth map generator 163 may transmit the generated depth map image to the database server 10 using the communication device 140. The database server 10 may receive, store, and manage the depth map image. If there is a request from a flight control device (not shown) of the aerial vehicle, the database server 10 may search for the requested depth map image and may transmit the found depth map image to the aerial vehicle.

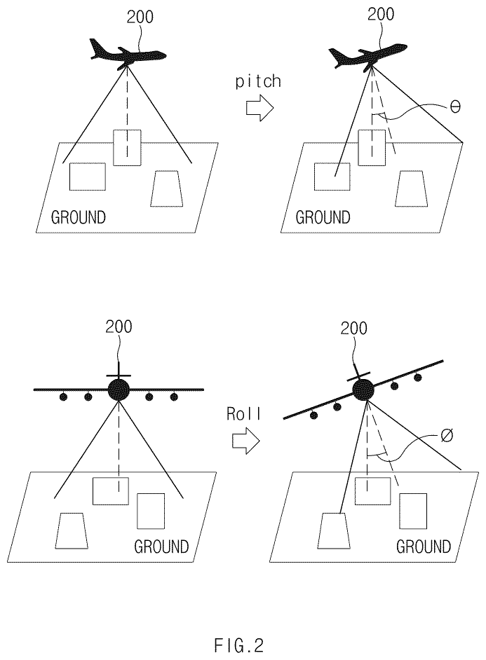

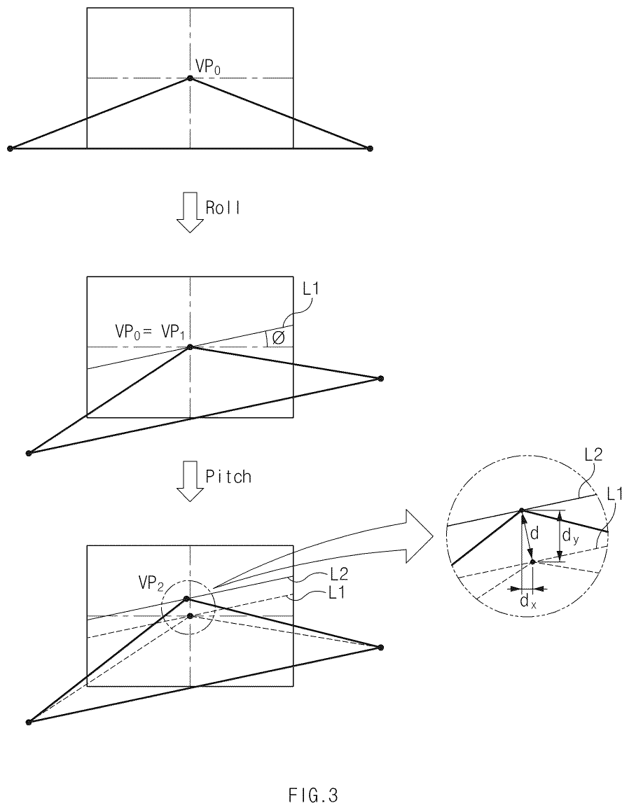

FIGS. 2 and 3 show an example of an image transformation method according to an example of the present disclosure.

Movement of an aerial vehicle 200 may be represented based on 6 degrees of freedom (DOF), X, Y, Z, roll, pitch, and yaw. A DSM may be represented as data (X, Y, Z) in a state in which roll, pitch, and yaw are “0”. An image obtained by a camera 110 may be represented as (x, y) data on a pixel coordinate system. Thus, image data and DSM data should be represented on the same coordinate system to match and fuse the image data with the DSM data.

An image processing device 161 may transform the image (or image data) obtained by the camera 110 into a bird-eye view image in a state in which each of roll and pitch is “0”. In other words, the image processing device 161 may transform coordinates of each pixel of the image into a coordinate system of the bird-eye view image (or a coordinate system of DSM data).

The image processing device 161 may correct the image obtained by the camera 110 based on posture information of the aerial vehicle 200 and posture information of the camera 110. As shown in FIG. 2, an installation angle of the camera 110 installed on the aerial vehicle 200, that is, pitch θ of the camera 110 may be fixed, but pitch θ and roll φ included in the posture information of the aerial vehicle 200 during flight may change. As the pitch θ and the roll φ of the aerial vehicle 200 change, as shown in FIG. 3, a position of a vanishing line changes on the image obtained by the camera 110 (L1→L2). The image processing device 161 may calculate a position change value of a vanishing point by a change in posture of the aerial vehicle 200 on the basis of the vanishing point located on the vanishing line to prevent the position of the vanishing line from changing on an image obtained by a change in posture of the camera 110 according to the change in posture of the aerial vehicle 200 and may correct an image obtained using the calculated position change value of the vanishing point to an image before the posture of the aerial vehicle 200 changes.

Referring to FIG. 3, if coordinates VP of the vanishing point of the image is VP₀ before pitch θ and roll φ of the aerial vehicle 200 change, although the roll φ of the aerial vehicle 200 changes, coordinates VP₁ of the vanishing point of the image according to a change in roll does not change to the coordinates VP₀ of the vanishing point of the image before the pitch θ and the roll q of the aerial vehicle 200 change. If the pitch θ and the roll φ of the aerial vehicle 200 change, the coordinates VP of the vanishing point of the image may move from VP₀ (=VP₁) to VP₂. The image processing device 161 may calculate a vertical distance between the coordinates VP₀ (=VP₁) of the vanishing point of the image before the pitch θ and the roll φ of the aerial vehicle 200 change and the coordinates VP₂ of the vanishing point of the image in which the pitch θ and the roll q of the aerial vehicle 200 changes, that is, a position change value of the vanishing point, using Equation 1 below.

$$d = tan ( {θ}_{c} + θ ) * \frac{{f}_{x} + {f}_{y}}{2} \qquad [ Equation 1 ]$$

Herein, fₓ may be defined as the focal length in the x-axis direction, and f_{y} may be defined as the focal length in the y-axis direction.

The image processing device 161 may calculate a vertical distance dₓ in the x-axis direction and a vertical distance d_{y} in the y-axis direction between the coordinates VP₀ of the vanishing point before the posture of the aerial vehicle 200 changes and the coordinates VP₂ of the vanishing point if the posture of the aerial vehicle 200 changes, using Equations 2 and 3.

$${d}_{x} = d * cos ( φ ) \qquad [ Equation 2 ]$$

$${d}_{y} = d * sin ( φ ) \qquad [ Equation 3 ]$$

The image processing device 161 may correct pixel coordinates of the image captured by the camera 110 using dₓ and d_{y} calculated by Equations 2 and 3 above. In other words, the image processing device 161 may change an image with the coordinates VP₂ of the vanishing point, which is captured by the camera 110, to an image with the coordinates VP₀ of the vanishing point.

The image processing device 161 may perform perspective transform for the corrected image. The image processing device 161 may apply a transform matrix P to calculate coordinates (x′, y′), the perspective transform of which is performed, for each of pixel coordinates (x, y) of the corrected image like Equation 4 below.

$$w ( \begin{matrix}{x}^{′} \\ {y}^{′} \\ 1\end{matrix} ) = ( \begin{matrix}{p}_{11} & {p}_{12} & {p}_{13} \\ {p}_{21} & {p}_{22} & {p}_{23} \\ {p}_{31} & {p}_{32} & {p}_{33}\end{matrix} ) ( \begin{matrix}x - {d}_{x} \\ y - {d}_{y} \\ 1\end{matrix} ) \qquad [ Equation 4 ]$$

Herein, w is the constant, and the transform matrix is that

$$P = ( \begin{matrix}{p}_{11} & {p}_{12} & {p}_{13} \\ {p}_{21} & {p}_{22} & {p}_{23} \\ {p}_{31} & {p}_{32} & {p}_{33}\end{matrix} ) .$$

As such, the image processing device 161 may transform the corrected image into a bird-eye view image by means of perspective transform.

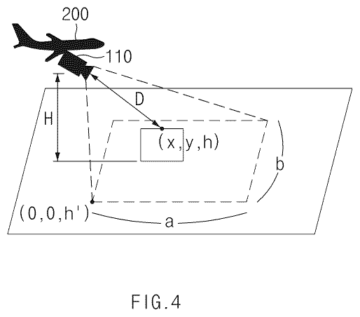

FIG. 4 shows an example of a method for generating a depth map by means of map matching according to an example of the present disclosure.

A map matching device 162 may perform data matching between a DSM and a bird-eye view image by means of map matching. In detail, the map matching device 162 may change image data from pixel-based (x, y) data to a frame of meter (X, Y) data which has the same real world units as DSM data to match the image data with the DSM data. The map matching device 162 may transform pixel (x, y) data into meter (X, Y) data using Equation 5 below. A transform ratio of meter to pixel in Equation 5 below may be determined in advance by means of calibration.

$$( pixel : meter = 1 : n ) \qquad [ Equation 5 ]$$

The map matching device 162 may move both the transformed data and the DSM data in parallel by using the center point of a landmark recognized by an image processing device 161 as the origin (0,0) to match the transformed data with the DSM data. The map matching device 162 may add Z information of DSM data (X, Y, h) with the same coordinates (X, Y) as coordinates (X, Y) of the image data which moves in parallel to generate data for three-dimensional (3D) coordinates (X, Y, h).

The map matching device 162 may transform the image data (X, Y, h) generated by matching the image and the DSM from data in meters to data in pixels. At this time, the map matching device 162 may change data (X, Y, h) in meters to data (x, y, h) in pixels using Equation 5 above.

The map matching device 162 may transform the transformed data (x, y, h) in pixels into a raw image (x, y, h) before correcting roll and pitch using inverse perspective transform. The map matching device 162 may perform inverse perspective transform using Equation 6 below.

$$w {P}^{- 1} ( \begin{matrix}{x}^{′} \\ {y}^{′} \\ 1\end{matrix} ) = ( \begin{matrix}x - {d}_{x} \\ y - {d}_{y} \\ 1\end{matrix} ) \qquad [ Equation 6 ]$$

A depth map generator 163 may estimate depth information D using the transformed data (x, y, h), current height information H of the aerial vehicle 200, and posture information of the aerial vehicle 200. The depth map generator 163 may calculate an angle α in an image width direction and an angle β in an image height direction for a pixel (x, y, h) using Equations 7 and 8.

$$α = {C}_{x} * \frac{( x - \frac{a}{2} )}{a} \qquad [ Equation 7 ]$$

$$β = {C}_{y} * \frac{( y - \frac{a}{2} )}{b} \qquad [ Equation 8 ]$$

Herein, a is the image width, be is the image height, and Cₓ and C_{y} are the width and the height of the field of view (FOV) of the camera (i.e., the camera 110).

The depth map generator 163 may estimate the depth information D based on height information h of the transformed data (x, y, h), the current height information H of the aerial vehicle 200, and the angles α and β. The depth map generator 163 may calculate the depth information D using Equation 9 below.

$$D = \frac{( H - h )}{cos α * cos β} \qquad [ Equation 9 ]$$

The depth map generator 163 may generate data (X, Y, D) using the estimated depth information D and may generate a depth map image using the generated data (X, Y, D). The depth map generator 163 may transmit the generated depth map image to a database server 10 through a communication device 140. The database server 10 may receive and store the depth map image transmitted from the depth map generator 163.

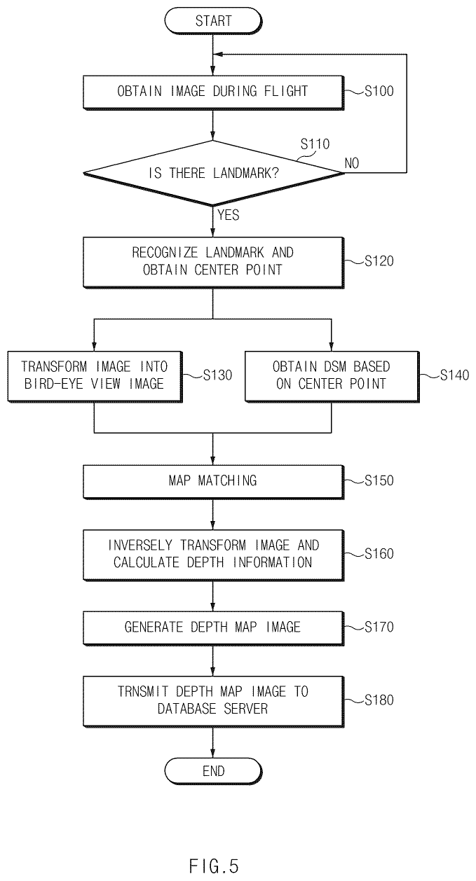

FIG. 5 shows an example of a method for generating a depth map according to an example of the present disclosure.

An apparatus 100 for generating a depth map may generate the depth map in a state in which an aerial vehicle is in flight. The apparatus 100 for generating the depth map may initiate a depth map generation function from a time point if a possibility of obtaining an image during flight, a possibility of normally operating a GPS/INS and obtaining data, a possibility of identifying DSM data, a possibility of obtaining a current posture and position of the aerial vehicle, or the like is identified. In other words, the apparatus 100 for generating the depth map may identify components 110 to 160 normally operate by means of self-diagnosis and may execute depth map generation.
In S100, a processor 160 of the apparatus 100 for generating the depth map may obtain an image during flight. The processor 160 may obtain a ground image using a camera 110 mounted on the aerial vehicle to face the ground. The camera 110 may obtain an image in the direction of the ground under an instruction of the processor 160 and may directly transmit the obtained image to the processor 160. The camera 110 may store the obtained image in the memory 150.
In S110, the processor 160 may determine whether there is a landmark in the obtained image.

If it is determined that there is the landmark in the obtained image, in S120, the processor 160 may recognize the landmark and may obtain a center point of the landmark. The processor 160 may recognize the landmark from the obtained image by means of a learning algorithm. The learning algorithm may learn information (or data) associated with the landmark located on a flight route of the aerial vehicle in advance. The landmark may be a geographic feature with symbolic meaning in a specific area. The processor 160 may obtain GPS reference coordinates (or GPS/INS reference coordinates) registered with the recognized landmark.
In S130, the processor 160 may transform the obtained image into a bird-eye view image. The processor 160 may obtain current posture information of the aerial vehicle from a navigation device 130. The posture information of the aerial vehicle may include information such as roll and/or pitch. The processor 160 may transform an image obtained based on the obtained posture information and pitch of the camera 110 (or a camera installation angle) into a bird-eye view image. The bird-eye view image may be defined as an image in a state in which each of roll and pitch is “0”.
In S140, the processor 160 may obtain a DSM on the basis of the center point of the landmark. The processor 160 may obtain DSM data to which (X, Y) coordinates of the center point of the landmark are identical. The processor 160 may obtain DSM data from a server (not shown) which provides the DSM data and may temporarily store the obtained DSM data in the memory 150.
In S150, the processor 160 may map-match the transformed bird-eye view image with the obtained DSM. The processor 160 may convert a horizontal and vertical position per pixel of the transformed bird-eye view image into meter units. Furthermore, the processor 160 may convert data units of the DSM into meter units. In other words, the processor 160 may allow a coordinate system of the transformed bird-eye view image and a coordinate system of the obtained DSM to be identical to each other. The processor 160 may map-match the bird-eye view image with the DSM to obtain an image including height information of the ground per image pixel.
In S160, the processor 160 may perform inverse transform (or inverse perspective transform) of the map-matched image. The processor 160 may match respective pieces of data by using the center of the landmark as the origin to add height data in meters. The processor 160 may perform inverse transform to change a coordinate system of the map-matched image to a coordinate system of a raw image. The processor 160 may calculate depth information of the image using the posture information and the height information of the aerial vehicle.
In S170, the processor 160 may generate a depth map using the calculated depth information. The processor 160 may change data (X, Y, h) in meters, which is obtained by means of the map matching, to data (x, y, h) in pixels, to generate a depth map. The processor 160 may replace the height information in the map-matched image with the calculated depth information to generate a depth map image which is a three-dimensional (3D) image (or a 3-channel image).
In S180, the processor 160 may transmit the generated depth map image to a database server 10. The depth processor 160 may transmit the generated depth map image to the database server 10 using a communication device 140. The database server 10 may receive and store the depth map image.

Examples of the present disclosure may generate a low-cost depth map with less data throughput using a digital surface model (DSM), altitude information of the aerial vehicle, and a mono camera of the aerial vehicle.

The present disclosure has been made to solve the above-mentioned problems occurring in the prior art while advantages achieved by the prior art are maintained intact.

An example of the present disclosure provides an apparatus and a method for generating a depth map to generate a low-cost depth map with less data throughput using a digital surface model (DSM), altitude information of an aerial vehicle, and a mono camera of the aerial vehicle.

Another example of the present disclosure provides an apparatus and a method for generating a depth map to obtain training data of the learning algorithm for estimating an altitude of an aerial vehicle using only an image sensor.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, an apparatus for generating a depth map may include a camera mounted on an aerial vehicle and a processor connected with the camera. The processor may obtain an image using the camera during flight, may transform the obtained image into a bird-eye view image, may map-match the bird-eye view image with digital surface model (DSM) data, and may generate a depth map image based on the map-matched image.

The processor may recognize a landmark from the obtained image and may obtain coordinates of a center point of the landmark.

The processor may obtain the DSM data on the basis of the coordinates of the center point of the landmark.

The processor may obtain posture information of the aerial vehicle from a navigation device, may correct the obtained image based on the posture information of the aerial vehicle, and may transform the corrected image into the bird-eye view image by means of perspective transform.

The posture information of the aerial vehicle may include pitch and roll information of the aerial vehicle.

The processor may transform data in pixels in the bird-eye view image into data in meters and may match the transformed data in meters with the DSM data to generate three-dimensional (3D) image data.

The processor may inversely transform the map-matched image into data in pixels by means of inverse perspective transform, may calculate depth information based on the inversely transformed data, height information of the aerial vehicle, and posture information of the aerial vehicle, and may generate the depth map image based on the calculated depth information.

The processor may replace height information of the map-matched image with the calculated depth information to generate the depth map image.

The processor may transmit the depth map image to a database server to store the depth map image in the database server.

The camera may include an electro-optics/infrared (EO/IR) sensor.

According to another example of the present disclosure, a method for generating a depth map may include obtaining an image using a camera mounted on an aerial vehicle during flight, transforming the obtained image into a bird-eye view image, map-matching the bird-eye view image with DSM data, and generating a depth map image based on the map-matched image.

The obtaining of the image may include recognizing a landmark from the obtained image and obtaining coordinates of a center point of the landmark.

The obtaining of the image may further include obtaining the DSM data on the basis of the coordinates of the center point of the landmark.

The transforming of the obtained image into the bird-eye view image may include obtaining posture information of the aerial vehicle from a navigation device, correcting the obtained image based on the posture information of the aerial vehicle, and transforming the corrected image into the bird-eye view image by means of perspective transform.

The posture information of the aerial vehicle may include pitch and roll information of the aerial vehicle.

The map-matching may include transforming data in pixels in the bird-eye view image into data in meters and matching the transformed data in meters with the DSM data to generate 3D image data.

The generating of the depth map image may include inversely transforming the map-matched image into data in pixels by means of inverse perspective transform, calculating depth information based on the inversely transformed data, height information of the aerial vehicle, and posture information of the aerial vehicle, and generating the depth map image based on the calculated depth information.

The generating of the depth map image based on the calculated depth information may include replacing height information of the map-matched image with the calculated depth information to generate the depth map image.

The method may further include transmitting the depth map image to a database server to store the depth map image in the database server.

Furthermore, examples of the present disclosure may obtain training data of the learning algorithm for estimating an altitude of the aerial vehicle using only an image sensor.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims. Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus comprising:
a camera mounted on an aerial vehicle; and
a processor coupled to the camera,
wherein the processor is configured to:
obtain, based on information from the camera during flight of the aerial vehicle, an image,
transform the obtained image into a bird-eye view image,
match the bird-eye view image with digital surface model (DSM) data,
generate, based on the matched bird-eye view image, a depth map image, and
output, based on the depth map image, a signal for an operation control of the aerial vehicle.

2. The apparatus of claim 1, wherein the processor is configured to recognize a landmark from the obtained image and obtains coordinates of a center point of the landmark.

3. The apparatus of claim 2, wherein the processor is configured to obtain, based on the coordinates of the center point of the landmark, the DSM data.

4. The apparatus of claim 1, wherein the processor is configured to:
obtain posture information of the aerial vehicle from a navigation device,
correct, based on the posture information of the aerial vehicle, the obtained image, and
transform, based on perspective transform, the corrected image into the bird-eye view image.

5. The apparatus of claim 4, wherein the posture information of the aerial vehicle comprises at least one of: pitch information of the aerial vehicle or roll information of the aerial vehicle.

6. The apparatus of claim 1, wherein the processor is configured to:
transform data in pixels in the bird-eye view image into data in meters, and
match the transformed data in meters with the DSM data to generate three-dimensional (3D) image data.

7. The apparatus of claim 1, wherein the processor is configured to:
inversely transform, based on inverse perspective transform, the matched bird-eye view image into data in pixels,
determine depth information based on the inversely transformed data, height information of the aerial vehicle, and posture information of the aerial vehicle, and
generate the depth map image based on the determined depth information.

8. The apparatus of claim 7, wherein the processor is configured to replace height information of the matched bird-eye view image with the determined depth information to generate the depth map image.

9. The apparatus of claim 1, wherein the processor is configured to store the depth map image in a database server.

10. The apparatus of claim 1, wherein the camera comprises at least one of an electro-optics sensor or infrared sensor.

11. A method comprising:
obtaining, based on information from a camera mounted on a flying aerial vehicle, an image;
transforming, by a processor, the obtained image into a bird-eye view image;
matching the bird-eye view image with digital surface model (DSM) data;
generating, based on the matched bird-eye view image, a depth map image; and
outputting, based on the depth map image, a signal for an operation control of the flying aerial vehicle.

12. The method of claim 11, wherein the obtaining of the image includes:
recognizing a landmark from the obtained image; and
obtaining coordinates of a center point of the landmark.

13. The method of claim 12, wherein the obtaining of the image further includes:
obtaining, based on the coordinates of the center point of the landmark, the DSM data.

14. The method of claim 11, wherein the transforming of the obtained image into the bird-eye view image includes:
obtaining posture information of the flying aerial vehicle from a navigation device;
correcting, based on the posture information of the flying aerial vehicle, the obtained image; and
transforming, based on perspective transform, the corrected image into the bird-eye view image.

15. The method of claim 14, wherein the posture information of the flying aerial vehicle comprises at least one of: pitch information of the flying aerial vehicle or roll information of the flying aerial vehicle.

16. The method of claim 11, wherein the matching the bird-eye view image with the DSM data comprises:
transforming data in pixels in the bird-eye view image into data in meters; and
matching the transformed data in meters with the DSM data to generate 3D image data.

17. The method of claim 11, wherein the generating of the depth map image includes:
inversely transforming, based on inverse perspective transform, the matched bird-eye view image into data in pixels;
determining depth information based on the inversely transformed data, height information of the flying aerial vehicle, and posture information of the flying aerial vehicle; and
generating the depth map image based on the determined depth information.

18. The method of claim 17, wherein the generating of the depth map image based on the determined depth information includes:
replacing height information of the matched bird-eye view image with the determined depth information to generate the depth map image.

19. The method of claim 11, further comprising:
storing the depth map image in a database server.

20. The method of claim 11, wherein the camera comprises at least one of an electro-optics sensor or infrared sensor.
